(19) United States
(12) Patent Application Publication
(10) Pub. No.: US 2007/0124721 A1
(43) Pub. Date: May 31, 2007

(54) PROXIMITY-AWARE VIRTUAL AGENTS FOR USE WITH WIRELESS MOBILE DEVICES

(75) Inventors: David Timothy Cowing, New York, NY (US); Benjamin Gabriel Taylor, New York, NY (US)

Correspondence Address: FISH & RICHARDSON P.C., P.O. BOX 1022, MINNEAPOLIS, MN, 55440-1022, US

(73) Assignee: ENPRESENCE, INC., New York, NY (US)

(21) Appl. No.: 11/560,263

(22) Filed: Nov. 15, 2006

Related U.S. Application Data
(60) Provisional application No. 60/736,729, filed on Nov. 15, 2005.

(51) Int. Cl. G06F 9/44

(52) U.S. Cl. 717/100

(57) ABSTRACT

Systems and methods are provided for facilitating the discovery of items, individuals, locations and business services that are relevant to the context of an individual (including, e.g., who an individual is, what an individual is looking for, where an individual is, the current time and/or date), facilitating post-discovery notifications (such as notifying the user or users), and executing post-discovery actions (such as making an offer to buy a product or prompting to add the user to an individual's personal network). Accordingly, in implementations of the present invention, agents are configured by the individual and deployed to or by the individual's computerized device (e.g., a mobile device, desktop computer, laptop computer, Internet appliance and/or server).

### CROSS REFERENCE TO RELATED APPLICATION(S)

This application claims the benefit of priority under 35 USC §119(e) of U.S. Provisional Patent Application Ser. No. 60/736,729, filed on Nov. 15, 2005, the contents of which are hereby incorporated by reference.

### TECHNICAL FIELD

This disclosure relates to proximity-aware virtual agents for use with wireless mobile devices.

### BACKGROUND

Agent-based technology has become increasingly important for use with applications designed to interact with a user for performing various computer-based tasks in foreground and background modes. Software agents generally relate to computer programs that are set on behalf of users to perform various tasks, including those that are routine, tedious and time-consuming. To be useful to an individual user, an agent should be personalized to the individual user's goals, habits and preferences. Thus, for optimal effectiveness, the agent should acquire user-specific knowledge from the user efficiently and effectively and utilize it to perform tasks on behalf of the user.

The concept of agency, or the use of agents, is well established. An agent is a person authorized by another person, typically referred to as a principal, to act on behalf of the principal. In this manner the principal empowers the agent to perform any of the tasks that the principal is unwilling or unable to perform. For example, an insurance agent may handle all of the insurance requirements for a principal, or a talent agent may act on behalf of a performer to arrange concert dates.

With the advent of the computer (including computerized devices, e.g., personal electronics such as PDAs and cellular telephones), a new domain for employing agents is available. Significant advances in the realm of software enable computer programs to act on behalf of computer users to perform routine, tedious and other time-consuming tasks.

Software agents differ from other software modules or applications because, rather than being defined in terms of methods and attributes, an agent is characterized in terms of its behavior. Software agents generally possess one or more of the following characteristics: persistence (code is not executed on demand but executes continuously and decides for itself when it should perform some activity); autonomy (agents have capabilities of task selection, prioritization, goal-directed behavior, decision-making without human intervention); social ability (agents are able to engage other components through some sort of communication and coordination, they may collaborate on a task); and reactivity (agents perceive the context in which they operate and react to it appropriately). To date, software agents generally have been utilized in computing environments having a high degree of available resources (e.g., memory and processing).

Moreover, there has been a recent proliferation of computer and communication networks, both wired and wireless. These networks permit users to access vast amounts of information and services without, essentially, any geographical boundaries. Modern networks include digital and analog cellular networks, wireless networks (e.g., wireless high bandwidth protocols described by IEEE standards 802.11b, 802.11a and 802.11g), the analog telephone network (e.g., POTS), voice over Internet protocol networks (known as “VoIP”), wired networks, cable television networks, and satellite-based networks. Thus, by interfacing with one or more networks, a software agent has a rich environment to perform a large number of tasks on behalf of a user.

Knowledge of a user's current location is another source of information. Although current applications are generally focused on navigation, a user's location can provide information, e.g., context, that a software agent can utilize. Location can be monitored using well-known techniques such as Global Positioning System (GPS) receivers. Such receivers are becoming increasingly affordable and compact. In addition, proximity technologies exist (e.g., utilizing the technologies described in IEEE specifications 802.15.1 (regarding Bluetooth®), 802.15.3a (regarding Wireless USB), 802.15.4 (regarding ZigBee™), and/or Radio Frequency Identification (“RFID”) protocols such as ISO 14443, EPC, and ISO 18000-6) that may not necessarily determine a user's absolute location, but can be used to determine when a user is near (or proximate to) a beacon or other compatible device.

### SUMMARY

In an aspect of the present invention, a system and method are provided for facilitating the discovery of items, individuals, locations and business services that are relevant to the context of an individual (including, e.g., who an individual is, what an individual is looking for, where an individual is, the current time and/or date), facilitating post-discovery notifications (such as notifying the user or users), and executing post-discovery actions (such as making an offer to buy a product or prompting to add the user to an individual's personal network). Accordingly, in implementations of the present invention, agents are configured by the individual and deployed to or by the individual's computerized device (e.g., a mobile device, desktop computer, laptop computer, Internet appliance, and/or server).

The details of one or more embodiments are set forth in the accompanying drawings and the description below. Various other features and advantages will be apparent from the description and drawings, and from the claims.

### BRIEF DESCRIPTION OF DRAWINGS

FIG. 1 depicts an illustrative screen layout (home screen) of the agent software.

FIGS. 2A-B depict illustrative screen layouts (match notice, presence list) of the agent software.

FIGS. 3A-C depict illustrative screen layouts (gallery screen, question screen, question response) of the agent software.

FIG. 4 is a schematic diagram of one embodiment of hardware employed in an exemplary proximity-aware virtual agent system.

FIG. 5 is a block diagram illustrating the software modules on an agent device.

FIG. 6 is a block diagram illustrating the modules of the central management services.

FIG. 7 is a block diagram illustrating the software modules of the Web Application.

FIG. 8 is a block diagram illustrating the software modules of the Remote Service Manager.

FIG. 9 is a block diagram illustrating software modules of the Agent Server.

FIG. 10 is a block diagram illustrating the software modules on a Point of Presence.

FIG. 11 is a flow diagram illustrating a method for executing virtual agents.

FIG. 12 is a flow diagram illustrating the evaluation of an agent match.

FIG. 13 is an object model diagram representing a logical view of virtual agents.

FIG. 14 is an object model diagram representing the logical view of user and service agents.

FIG. 15A is an object model diagram representing the logical view of user attributes and user items.

FIG. 15B is an object model diagram representing the logical view of service attributes and service items.

### DETAILED DESCRIPTION

The following is a description of preferred implementations, as well as some alternative implementations, of a system and method for proximity-aware virtual agents for use with agent devices.

In some implementations, a network of devices that execute agents is deployed that execute agents. The agents receive information (e.g., from users) relating to goals. For example, an agent can be configured to look for a compatible romantic match having certain characteristics. When devices (which may be referred to as “agent devices”) are sufficiently near each other, the agents poll each other to determine whether a match is found (i.e., if another user has the desired characteristics). If a match is found, various notification and post-match functions can be performed. If a match is not found, the agent keeps looking for a match. Moreover, an agent can let a user know when his contacts (e.g., friends, business associates, etc.) are nearby. While proximity is one trigger for executing an agent, it is possible for an agent to poll the entire network looking for match.

More particularly, an agent preferably includes a set of parameters that describe the dimensions a user might use in seeking to attain a particular goal. The goal can include meeting or communicating with a particular person, arriving at a particular place, and finding and/or purchasing a particular product or service. Specific values are assigned to these parameters by a user to describe the goal (e.g., a person, place, product, or service) he wishes to attain. In some implementations, when an agent finds what the user is looking for, i.e., the goal, it is referred to as a “match.” There is no requirement that an agent terminate after a match. To the contrary, some agents may provide a user with multiple matches (e.g., finding a product from multiple sources, and then allowing the user or agent to determine the best option based on cost or availability). Additionally, the agent may have arbitrary descriptive data associated with it that the user may view wherever they are (e.g., a map, image, home page, status indicator), as well as instructions on what to do following a match.

Agents can be suited for use in, but not limited to, matching of individuals for romantic, social, or business purposes, identifying items a user is shopping for, contextually relevant advertising, and group-based games. For example, a dating agent could identify a potential romantic match between two individuals that are at the same social gathering (determined, e.g., by utilizing location or proximity information) by comparing information about their ideal mates with information about each other. The agent would then alert the two users, and provide some basic information (such as any friends, business contacts, or interests they may have in common) to facilitate an introduction. In the preferred embodiments, agents provide the ability to add personalized functionality to a agent device platform without having to deploy a whole new set of software to the device.

Agents preferably are designed to be compatible with and executed on a wide array of devices. To that end, agents can include a set of meta-data that executes on a platform that can execute the agent as defined in the meta-data. Accordingly, agents can be easily added to agent devices without the need of additional support software, i.e., once the platform is loaded on the agent device, a user is free to add additional agents. The light-weight nature of this design makes them ideally suited to resource constrained environments, such as mobile phones, PDAs, and other portable and consumer electronics. Thus, agent devices can take many forms, including higher resource environments such as desktop PCs, laptop PCs, and servers.

Additionally, the agents can operate in environments where security constraints preclude the execution of arbitrary code (for example, a Java™ Platform Micro Edition sandbox, implemented in, e.g., the mobile information device profile (e.g., MIDP JSR 37, JSR 118, or JSR 271) or personal profile (e.g., CDC JSR 36 or JSR 218)). The software on the agent device can be written in, e.g., C++ or any other language/platform that can interface with the agent device operating system and application programming interface (“API”).

In some implementations, the agents are configured and managed via a web site (or other network interface) and either transferred to the user's agent device via a synchronization process or executed on the server while communicating with the user's agent device. A user may have multiple agents active at any point in time. While users may use their agent device to modify the agent in real time, the small form factor of some agent devices makes data entry challenging and thus may encourage users to utilize, e.g., a larger form factor device (e.g., a laptop or desktop PC) and web interface for the data entry required to initially configure an agent.

Agent Device Software Application

An aspect of some implementations is a software application that is executed on an agent device, e.g., a mobile phone or Personal Digital Assistant (PDA). This application provides a user interface and set of menu-controls allowing the user to interact with it. Additionally, it provides the engine for detection of other people, locations, services, or products nearby and for the evaluation of potential matches with each person, location, service, or product utilizing the parameters of a user's agent or agents to discover if the person, location, service, or product is of interest to the user. The user typically will leave the application executing on his agent device so it can continually search for people, locations, services, or products nearby.

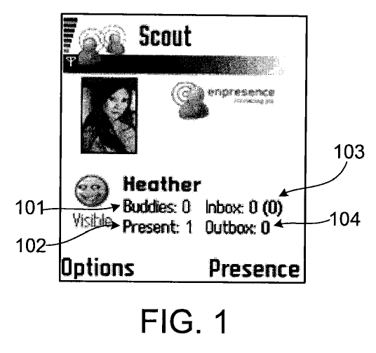

A substantial portion of the activity on the user interface centers around a few core screens: the home screen, the presence list, the match notice, and the offer screen (used to display advertisements). An illustrative example of a home screen is shown in FIG. 1. The home screen shows summary information for the user, including the number of buddies (i.e., those individuals that the user has identified as contacts) in the area 101, the number of people using the service in the area (labeled present 102), as well as the number of messages in the user's inbox 103 and outbox 104. From the home screen, the user can access other screens through the menus.

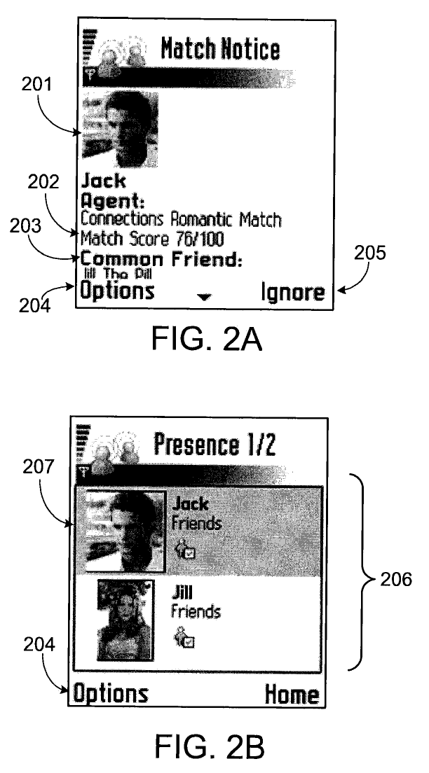

When a match is detected in the area, the user is presented with a pop-up match notice that contains some set of information about the person, location, service, or product with which the match occurred. An illustrative example of a match notice screen is shown in FIG. 2A. In this example, the match pertains to a person, and more particularly, is a romantic match. As shown, a photo of the match 201 is provided, as well as a match score 202 that is calculated based on the degree to which the dimensions entered by the user match those possessed by the match. The user, agent, or agent provider (i.e., the party who developed or distributed the agent) can set a threshold match score that must be met before a match alert is generated. The match screen further provides some information about the match. In this case, the user is informed that the match and user share a common friend 203. The match notice screen also gives the user the option of taking action on the match. By selecting the options soft key 204, the user can view additional information, add the person to their relationships, or perform the post-match action defined by the agent. Alternatively, the user can ignore the match by selecting the ignore soft key 205.

When people, locations, services, or products with which the user has a relationship are nearby, they appear on the presence list. An illustrative example of a presence list is shown in FIG. 2B. Whether a user has a relationship with a particular person, location, service or product can be based on, e.g., (1) the result of an agent finding a match or (2) a user manually entering certain people, locations, services, or products into the agent. From the presence list 206, the user may utilize the options soft key 204 to access additional information about the person, location, service, or product, communicate with the person, location, service, or product, or manage his relationship with the person, location, service or product. For example, the user can highlight an entry on the presence list (in this example Jack, entry 207, is highlighted), and proceed to (1) retrieve additional information about Jack (e.g., from data stored on Jack's agent device or from data associated with Jack elsewhere in the network), (2) communicate with Jack (e.g., telephonically, text message, photo message, video message), and/or (3) change the relationship status with Jack (e.g., delete him from the presence list, change him from a personal contact to a business contact, enable/disable proximity notification, set privacy settings).

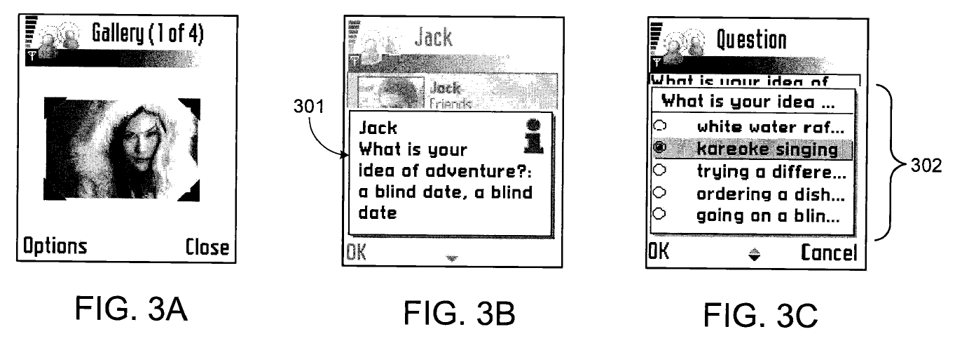

An example of information that can be retrieved about a match is a picture gallery containing a set of images that others can view. An illustrative example of such a picture gallery is shown in FIG. 3A. As in this example, a user can have pictures of herself. The user also (or instead) can include images of her business card, resume, or things representing her personal interests. If the match is a product, the image gallery can contain, e.g., images of the product, instructions, capabilities, and/or locations to purchase the product. If the match is a location, the image gallery can contain, e.g., images of the location, nearby landmarks, and the staff currently on duty. If the match is a service, the image gallery can contain, e.g., images of where the service can be found, the person(s) performing the service, and past results. Match information for people, products and services can be found in the form of text, images, structured data, links, audio, video and other device consumable or actionable formats.

A user can communicate with others in a variety of ways, including writing his own messages, sending pre-written messages, or using standard questions. Users can communicate with others as a result of an agent finding a match, or a user may manually select a person, location, product or service via the presence list. Standardized questions are an aspect of the question wizard feature. Standardized questions allow individuals to get more information about a person, location, service or product without having to spend a lot of time writing messages back and forth. Standardized questions are customized for different categories of people (e.g., romantic, friend, or business), locations (e.g., parks, stadiums, or restaurants), products (e.g., consumer electronics, foodstuffs, automobiles) or services (e.g., medical services, accountants, plumbers, contractors, car services). An illustrative example of romantic standardized questions are shown in connection with FIGS. 3B and 3C. When the recipient receives a question 301 (as in FIG. 3B), the user can select from multiple-choice list 302 (as shown in FIG. 3C) and the results are returned to the originating user. One of skill in the art could appreciate that many different type of standardized questions can be associated with the different categories of people, locations, services, and products.

Additional Features of the Agent Device Software Application

The user interface and agent device support many other features. For example, proximity detection detects the presence of nearby agent devices or known fixed locations (e.g., point of presence beacons or products) through, e.g., wireless technology such as Bluetooth® point of presence detection, RFID, ZigBee™, WiFi®, or WiMax or comparison to a geographic location stored in a database. Presence detection may utilize, e.g., Bluetooth® discovery, GPS (or assisted GPS) proximity detection, or other detection mechanisms. The detection of another agent device or fixed location can trigger the friend finder and matching agent capability as is appropriate (discussed below).

The friend finder feature notifies the user when others are nearby with whom the user has an existing relationship. The presence list (e.g., FIG. 2B) shows basic information (e.g. user alias, picture, and relationship category) for each related user that is nearby. Relationships can be stored in a list on the agent device, as well as in a central database, and can be managed both through the mobile application user interface and the web site.

The matching agents look for people, locations, services, or products nearby that match the user's interest, based upon information the user has entered for the parameters of each agent. For example, a user in the market for an automobile may set parameters to indicate that he is looking for a 2004 low-mileage black sedan with a manual transmission and leather seats. The matching agent will look for, e.g., nearby car dealerships or individuals selling an automobile matching those parameters. If one is found, the matching agent will alert the user with details regarding the match. For example, if a car dealership is found, the name of the dealership, a photo of the car and directions to the dealership may appear. If an individual selling the car is found, the matching agent can display a picture of the individual (to simply identification) and a photo of the car. The matching agent also can effect communication between the parties. The matching agent also may alert the match that it has been discovered by the user.

The anonymous messaging feature allows a user to exchange messages with other users (including, e.g., people, location, services, or products) without revealing his mobile phone number. This provides an advantage over certain existing text messaging technology, e.g., short message service (known also as “SMS,” standard GSM 03.41) which includes the sender's mobile phone number and provides no anonymity. Messages can be sent over the peer to peer network (e.g., from agent device 418 to agent device 420) as well as anonymously via SMS with messages routed through a central server (e.g., central server 408).

The question wizard feature, discussed in connection with FIGS. 3B and 3C, provides standardized questions with quick select answers so a user can pose questions to his friends and matches (from the matching agent) without typing a word.

The photo gallery feature, discussed in connection with FIG. 3A, allows a user to view other user's picture galleries on an agent device. It helps users recognize faces in the crowd and evaluate any matches before meeting in person.

The instant messaging feature connects with internet instant messaging services, allowing users to chat with friends on the internet, as well as those on agent devices. Preferably, the mobile application integrates instant messaging with proximity, thereby providing indications of when a user's friends are nearby and/or online.

Architecture Overview

In a particular implementation, the agent software application (i.e., the one executed on the agent device) is supported by a broader set of infrastructure, consisting of both a set of central services, distributed points of presence, and user's access via the web or other network. For example, a user is able to create and update information on his PC using a web browser to access a secure internet site containing his information. Information entered into the user database via the website is synchronized to the agent device via an XML-based synchronization procedure that synchronizes new or updated information from the user database to the agent device and synchronizes new or updated information from the agent device to the user database. Additionally, the agent device may communicate with one or more central servers to support additional functionality, such as communication with other users, internet instant messaging, GPS proximity detection, RFID-based item identification, people locators, or remote agent match evaluation. The agent software application also may detect and communicate with fixed points of presence to provide one way of detecting fixed locations of interest.

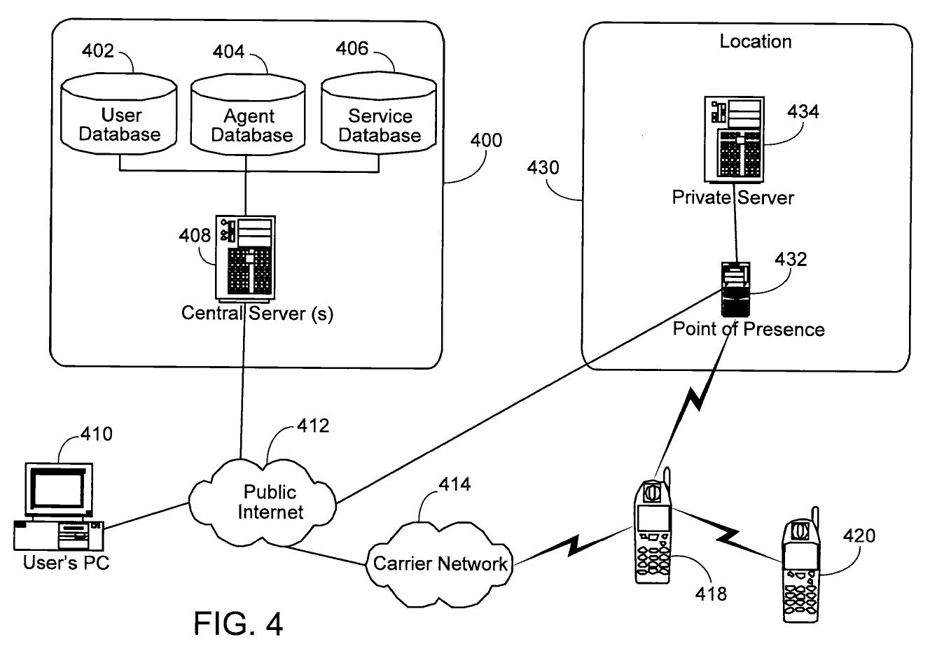

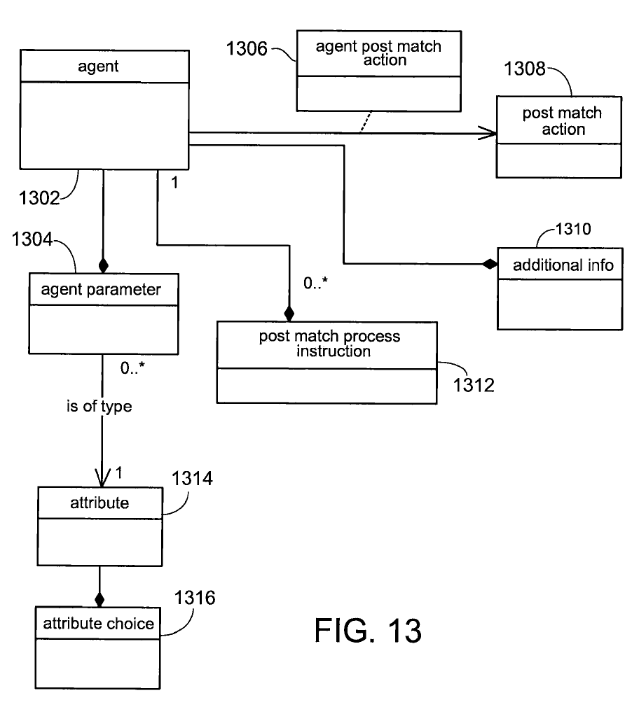

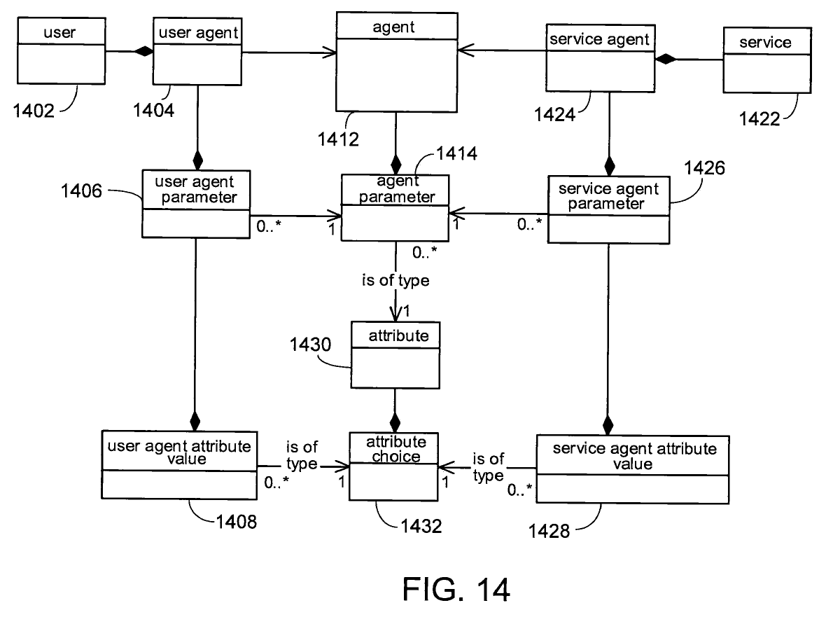

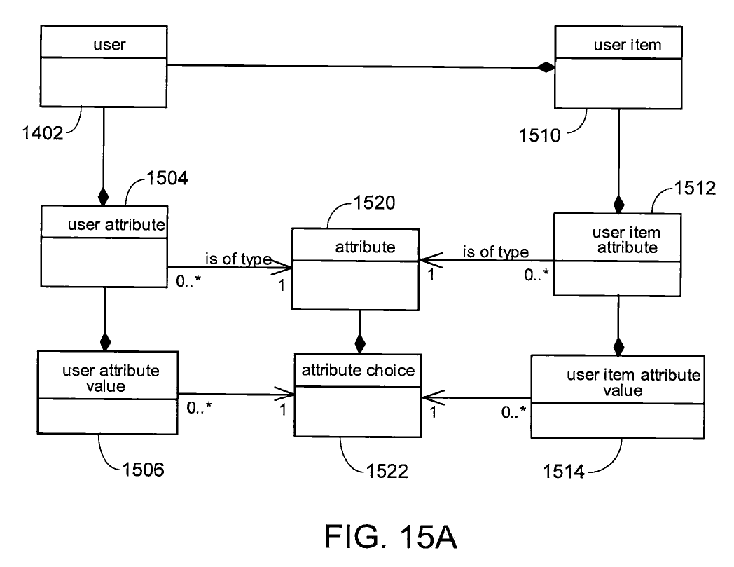

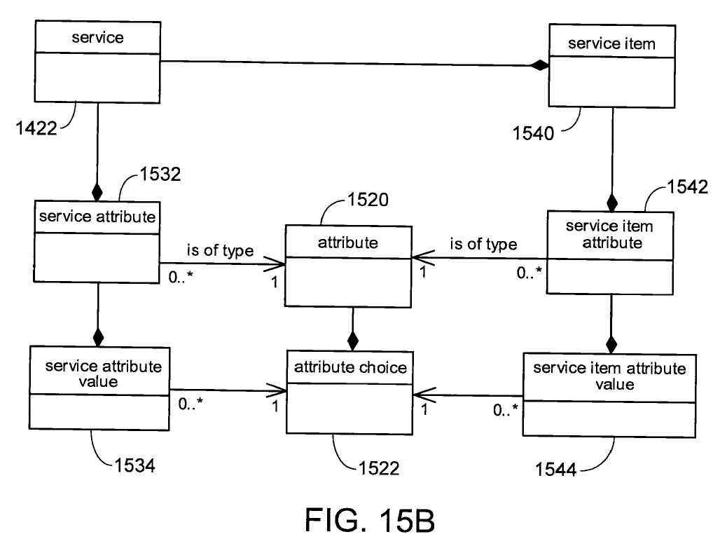

FIG. 4 is a schematic outlining the physical infrastructure of an implementation. User, agent, and service data, along with core processing functions, are housed in a central hosting facility 400. Multiple hosting facilities may be used as desired to provide redundancy, fault tolerance and scalability. A user database 402 stores user information, including the data of the user, user agent, and user item objects, as well as supporting attribute value data (user attribute, user agent attribute, and user item attribute). The information in the user database 402 is discussed in more detail in connection with FIG. 15A. An agent database 404 stores data defining the agents, including the data of the agent, agent attribute, and attribute objects. The information in agent database 404 is discussed in more detail in connection with FIGS. 13 and 14. A service database 406 stores service information, including the data of the service, service agent, and service item objects, as well as supporting attribute value data (service attribute, service agent attribute, and service item attribute). More detail regarding the information in service database 406 is provided in connection with FIG. 15B.

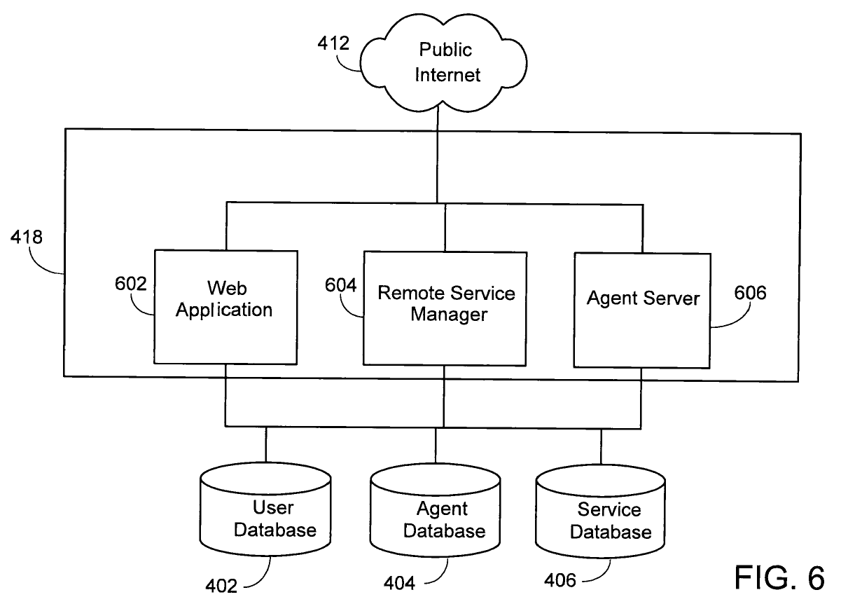

Additional databases may be provided for further categories of data. These databases may be physically deployed in a single database, or partitioned across multiple database instances and machines as required to support performance and fault tolerance requirements. A central server 408 is utilized to execute the server applications of the system, including the web application, the remote service manager, and the agent server (see discussion of FIG. 6). The application and application components may be partitioned across multiple physical servers and hosting locations as required to support performance and fault tolerance requirements. A user can connect to the web application from a mobile device or personal computer (PC) 410 using a web browser over the public internet 412 to create and maintain his profile, including, e.g., user, user agent(s) and user item data, as well supporting attribute data. This also represents one manner in which a user can download agents (e.g., those stored on the agent database 404, central server 408, or third party agents stored on private server 434 or point of presence 432) onto his agent device 418 or 420.

A user downloads and executes the agent platform on his agent device 418 (in this example, a cellular phone, but the user's PC 410 could be an agent device as well). In the illustrated embodiment, the agent device supports Java™ Micro Edition (J2ME™), JSR-82 and/or JSR-179. Once the agent platform is on the agent device, the user is free to add additional agents to his agent device without the need to update or download additional software. The agents on the agent device 418 can interact with another agent device 420 executing the software or a local point of presence 432. The agent device 418 or 420 can communicate with the central server 408, other agent devices or other servers via standard mobile and internet protocols (e.g., SMS, MMS, HTTP, WAP, IP) over the network 414 of the carrier with whom the user has a subscription for mobile voice/data services. Some carriers have multiple networks, and as such, the agent device can use any of the carrier's networks. Alternatively, a carrier may allocate one of its networks or a certain part of bandwidth for communication in other ways.

A location 430, such as a retail store or a bar, may make itself known to the system by installing a local point of presence beacon 432. The point of presence beacon 432 can include, e.g., a PC, a workstation, server, internet appliance or hub that communicates with the central agent server and remote service manager (of central server 408, see also items 604 and 606 of FIG. 6) over a network, preferably, the public internet 412. The point of presence beacon 432 also can include storage capability and means for wireless communication and proximity detection (e.g., to alert agent devices when they are nearby). A point of presence also may provide content to users. In the case of a retail store, the content may include product inventory, product images, product prices and store hours. Such information can be stored on a private server 434 that communicates with point of presence beacon 432. The contents of private server 434 are not directly accessible to users, but rather the point of presence beacon 434 acts as a liaison between users and the private server 434. Private server 434 may be remote to point of presence beacon 432. However, it is also possible to integrate the point of presence beacon 432 and private server 434 into a single piece of hardware, e.g., a server that both stores content data and performs the functions of the point of presence beacon 432. Point of presence beacon 432 can communicate with central server 408 via a private network or a virtual private network (“VPN”).

Agent Device Software Application Architecture

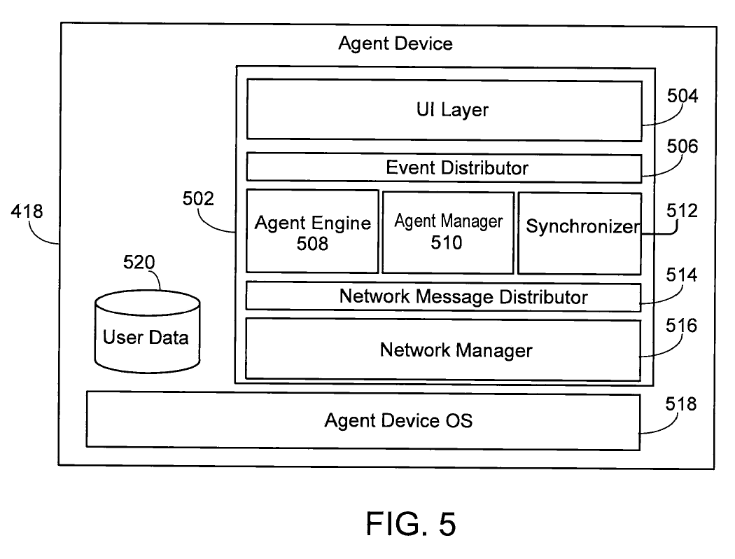

FIG. 5 is a block diagram representing the components of the virtual agent platform 502 that reside on an agent device, e.g., 418 of FIG. 4. As discussed, the agent device may be any number of electronic devices, including a mobile phone, personal digital assistant (PDA), PC, or a mobile device with an operating system (OS) that supports third party software (i.e., software not created by the device manufacturer). The agent device OS 518 provides functions for interfacing with the agent device hardware, including network access, Bluetooth®, PAN (personal area network), WPAN (wireless personal area network), global positioning system (GPS), storage, memory management, other applications and data executing on the agent device and other capabilities common in operating systems. In some embodiments, the virtual agent platform utilizes the Java™ 2 Platform, Micro Edition (J2ME™) standard, along with the related CLDC (JSR-30, JSR-139) and MIDP (JSR 118) standards.

User information is stored in the user data store 520 on the agent device 418. This includes the user, user attribute, user agent, user agent attribute, user item, and user item attribute data (see FIGS. 14 and 15A). This data can be replicated onto the user database 402 of FIG. 4. The virtual agent platform is made up of a number of key modules. The user interface (UI) layer 504 is responsible for displaying information to the user and accepting user input. This includes displaying a list of agents available on the device, displaying notifications or other post-match agent actions, and accepting user response to the action. The event distributor 506 provides a light-weight mechanism for letting the user interface or other modules know about events published by other modules. Examples of these events might be an agent match or the discovery of a nearby user or point of presence. The network manager 516 manages all interaction with a number of network protocols and types, including data connectivity with the central services using HTTP and/or IP, SMS receipt/sending, Bluetooth® or other PAN network connectivity, and location services. The network message distributor 514 routes incoming network messages to the appropriate network message handler. Handlers are registered to handle specific network messages according to a message type identifier.

On the agent device 418, the core agent functionality is handled by an agent manager 510 and an agent engine 508 with support from a synchronizer 512. The agent manager 510 determines whether to deploy zero or more agents when another user, item, or service is within a defined proximity of the agent device or when it receives another event relevant to an agent. The agent manager 510 receives events from the network and deploys the appropriate agent registered to handle one or more events. The agent engine 508 performs the actual evaluation of the agent utilizing the agent parameters and the appropriate attribute data of the target user, service or item. Certain agents, known as proxy agents, cause the agent engine 508 to communicate with the central agent server (e.g., server 408 of FIG. 4) for evaluation of the agent. This is useful for more complex agents where the processing could overwhelm the capabilities of the agent device 418, or that is otherwise better executed on a more robust platform like central server 408. The synchronizer 512 manages the replication of data to and from the relevant databases, including user, user attribute, user agent, user agent attribute, user item, and user item attribute data (e.g., user database 402 of FIG. 4).

Central Service Architecture

FIG. 6 depicts components of the central services in greater detail. Web application 602, remote service manager 604, and agent server 606 are aspects of a central server, e.g., 408 of FIG. 4. While it is preferred that all of these aspects are integrated into a single server, for purposes of fault tolerance, scalability, and/or reliability, each aspect 602, 604, and 606 may reside on separate servers. Each aspect 602, 604, and 606 can utilize application server technologies and languages, e.g., C#, C++, Perl, and PHP (hypertext preprocessor). The web application 602 provides users with the ability to create, manage, and update the data about themselves (user and user attribute), their agents (user agent and user agent attributes) and their items (user item and user item attribute). The remote service manager 604 provides the communication link to the agent device. It can utilize web services, e.g., HTTP, IP, and XML, to support this communication. The agent server 606 provides server-based ability to initiate and evaluate agent matches. This may be used to facilitate server-side matching in support of the website, or to support proxied agent evaluation. Proxied agent evaluation occurs when the agent software application determines that an agent it is evaluating is proxied (the agent has a flag indicating if it is proxied or not), and the agent software application makes a request to the agent server to evaluate the agent. As discussed in connection with FIG. 4, data that supports these processes are stored in the user database 402, agent database 404 and service database 406.

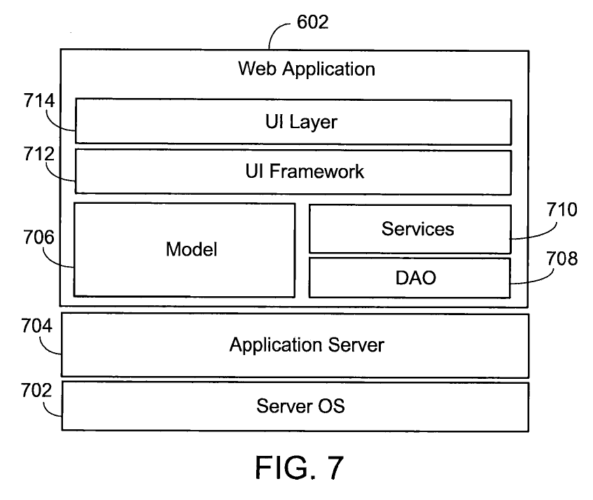

FIG. 7 is a block diagram depicting components of the web application 602. The web application 602 is designed to be executed by a server (e.g., server 408 of FIG. 4) and utilize the server capability, including storage and memory management, networking and computational power, via the server OS 702. In the illustrated embodiment, the web application executes within a Java™ 2, Enterprise Edition (J2EE™) application server 704 to provide the basic functionality of a web-enabled application, including session management, load balancing, server-side scripting, user authentication and authorization, and process partitioning. The basis of the web application is a model-view-controller (MVC) architecture which separates the user interface pages, the navigational logic and the business logic. The model 706 contains a physical implementation of the object model detailed in FIGS. 13, 14, and 15A. The object model describes the framework utilized by the agent matching process to find matches.

The user interface (“UI”) layer 714 produces the web pages the user sees in his browser. These pages consist of many sub-components to facilitate reuse of common visual elements, such as a page header, footer, and main menu. Navigation or the control part of the MVC architecture is handled by the UI framework 712, which handles browser requests by getting the appropriate model objects and feeding them to a view in the UI layer. The UI framework 712 also supports the submittal of hypertext markup language (“html”) forms with data from the user, the validation of the data, and the incorporation of the data into the model 706. The data access object (DAO) model 708 mediates between the underlying databases (e.g., databases 402, 404, and 406 of FIG. 4) and the model 706 and encapsulates all necessary logic to do so. The services layer 710 provides the UI framework 712 with a series of methods to access the DAO 708 for retrieving, updating or storing objects in the database.

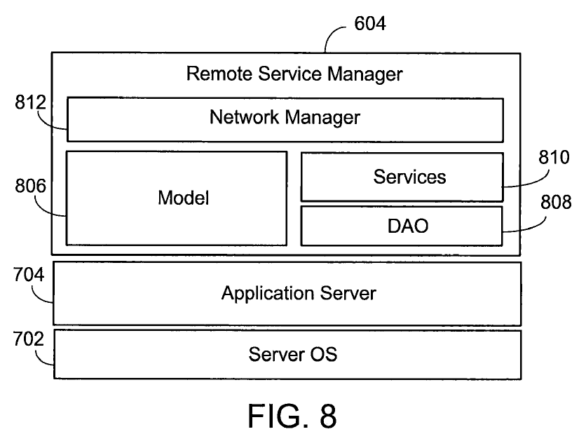

FIG. 8 is a block diagram depicting components of the remote service manager (RSM) 604. The remote service manager is designed to be executed by a server (e.g., server 408 of FIG. 4) and utilize the server capability, including storage and memory management, networking, and computational power, via the server OS 702. In the illustrated embodiment, the remote service manager executes within a Java™ 2, Enterprise Edition (J2EE™) application server 704 to provide the basic functionality of an internet-enabled service, including session management, load balancing, server-side scripting, user authentication and authorization, and process partitioning. The model 806 contains a physical implementation of the object model detailed in FIGS. 13, 14 and 15A. The network manager 812 handles inbound requests for the RSM by providing networking, authentication and authorization, and request routing. Inbound requests are routed to registered handlers according to an identifier in the message. The data access object (DAO) model 808 mediates between the underlying databases (e.g., databases 402, 404 and 406 of FIG. 4) and the model and encapsulates all necessary logic to do so. The services layer 810 provides the network manager 812 with a series of methods to access the DAO 808 for retrieving, updating or storing objects in the database. The services layer 810 also contains the handler for synchronizing messages from an agent device.

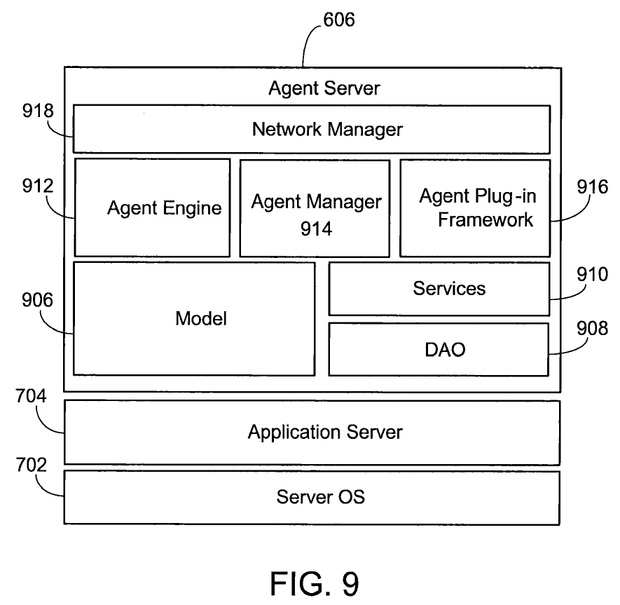

FIG. 9 is a block diagram depicting components of the agent server 606. The agent server is designed to be executed by a server (e.g., server 408 of FIG. 4) and utilize the server capability, including storage and memory management, networking and computational power, via the server OS 702. In the illustrated embodiment, the agent server executes within a Java™ 2, Enterprise Edition (J2EE™) application server 704 to provide the basic functionality of an internet-enabled service, including session management, load balancing, server-side scripting, user authentication and authorization, and process partitioning. The model 906 contains a physical implementation of the object model detailed in FIGS. 13, 14 and 15A. The network manager 918 handles inbound requests for the agent server by providing networking, authentication and authorization, and request routing. Inbound requests are routed to registered handlers according to an identifier in the message. The data access object (DAO) model 908 mediates between the underlying databases (e.g., databases 402, 404 and 406 of FIG. 4) and the model 906 and encapsulates all necessary logic to do so. The services 910 layer provides the network manager 918 with a series of methods to access the DAO 908 for retrieving, updating or storing objects in the database.

The core capability of the agent server 606 is handled by an agent manager 914 and an agent engine 912, with an agent plug-in framework 916 providing a mechanism for customized agent handling. The agent manager 914 in the agent server 606 is similar in function to the agent manager on the agent device (e.g., item 510 of FIG. 5), in that it is responsible for deciding when to initiate agent matches. However, the agent manager 914 on the server is capable of handling a much larger volume of input triggers (e.g., the proximity of two users) and resulting decisions. The agent manager 914 would be used for server-side triggers, such as when proximity detection occurs on the server (e.g., with proximity detection between two devices using GPS or Bluetooth®). The agent engine 912 is responsible for evaluating an agent match with a target. It is used when the agent manager 914 determines an agent match should be initiated or when an agent device requests an agent match from a proxy agent.

Although discussed separately, the model, services and DAO modules can be shared by the web application 602, the remote service manager 604 and the agent server 606 as standard building blocks of each of these applications. In the illustrated embodiment, these modules are implemented as a Java™ library (also known as a “JAR”) that each of the applications includes. Moreover, each module can share a common application server and operating system. Each module could alternatively be executed in separate application servers and operating systems.

Point of Presence Architecture

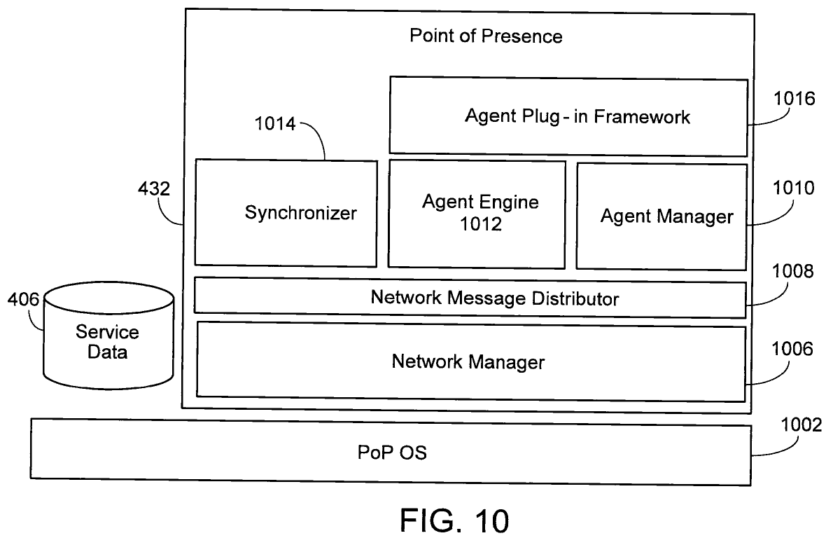

FIG. 10 is a block diagram depicting components of a point of presence beacon, e.g., 432 of FIG. 4. Preferably, the point of presence beacon is designed to sit on small footprint device that contains a light weight OS 1002, such as Linux, a Bluetooth® radio transceiver (and/or other wireless communication capabilities), a network connection and data storage capability. On the point of presence beacon 432, the core agent functionality is handled by an agent manager 1010 and an agent engine 1012, with agent plug-in framework 1016 providing a mechanism for customized agent handling and with further support from a synchronizer 1014. The network manager 1006 handles inbound requests for the point of presence 432 by providing networking, authentication and authorization, and request routing. The agent manager 1010 determines whether to deploy zero or more agents when a user (e.g., agent device) is within proximity of the point of presence 432. The agent engine 1012 performs the actual evaluation of the agent utilizing the agent parameters and the appropriate attribute data of the target user, service or item. Certain agents, known as proxy agents, cause the agent engine 1012, via the network message distributor 1008, to communicate with the central agent server (e.g., server 408 of FIG. 4) for evaluation of the agent. This is useful for more complex agents where the processing could overwhelm the capabilities of the agent device. The synchronizer 1014 manages the replication of data to and from the relevant databases, including service, service attribute, service agent, service agent attribute, service item and service item attribute data (e.g., to and from database 406). Synchronizer 1014 may also manage the replication of data with a point of presence server, e.g., 434 of FIG. 4.

Point of presence beacons can actively scan for the proximity of agents and when detected, send point of presence-initiated match requests and offer match requests. If the response to an offer match request is that a match has occurred, the appropriate offer content can be transmitted to the matched agent device and displayed and/or handled by the agent device.

An alternative light-weight implementation of the point of presence beacon includes the network manager 1006 and the network message distributor 1008. In this configuration, the network message distributor proxy 1008 forwards all requests to the central agent server for handling (e.g., server 606 of FIG. 6). This configuration is useful for smaller footprint devices that have less memory and little/no storage capability. Alternatively, requests (or portions thereof) could also be forwarded to a point of presence server for processing, e.g., 434 of FIG. 4.

Agent Device Discovery Process

Device discovery is the process by which one agent device executing the agent software application discovers that another agent device is nearby. The agent device may be that of, e.g., an individual, point of presence, location, service or item. Device discovery can trigger significant functionality, including the friend finder and agent matching features. Device discovery can work with a variety of communication or location means, e.g., a peer-to-peer radio technology such as Bluetooth® or with a position detection system such as GPS. The user or agent can control the rate of device discovery as a way to manage power consumption. Additionally, the device discovery mechanism can adjust its rate, based on the number of agent devices discovered. If the process is not finding any agent devices, it will slow down the rate of discovery to conserve power. The rate will speed up if more agent devices are discovered.

Device discovery utilizing a peer to peer radio technology such as Bluetooth® is based on a polling mechanism. In the agent software application, a thread or process periodically conducts a Bluetooth® scan to detect the presence of other Bluetooth® devices of the correct set of classes (Bluetooth® devices are generally classified according to a Class of Device within the Bluetooth® specification). When another Bluetooth® device is within the range in which can be detected (i.e., some predetermined distance that can vary based on the receiver, transmitter, and surrounding conditions), its presence is detected. The particular classes of device this thread attempts to detect (with Bluetooth® major/minor class of device in parenthesis) include, for example, mobile phones (phones-cellular/smart phone), PDAs (computer-handheld/palm-sized/wearable computer), and points of presence (computer-server). Each new device detected (i.e., one that the agent software application has detected and has not left the vicinity) is queried to determine if it is publishing a Bluetooth® service for the agent software application. If so, a handshake is executed to ensure it is executing the agent software application, and to exchange some core data (e.g., a user identifier). Once a successful handshake occurs, detection is considered complete and an event is sent that triggers, e.g., the friend finder and agent matching features. The Java™ software on the agent device may utilize vendor proprietary APIs for Bluetooth® discovery.

Device discovery utilizing location detection systems such as GPS utilize a polling mechanism, combined with a central server that stores individual location information and detects proximity. In the agent software application, a thread or process periodically queries the agent device's GPS module for the current location (defined by a latitude and longitude). A comparison is done with the prior location to determine if the agent device has moved beyond a predetermined distance. If the device has moved more than the predetermined distance (or this is the first location reading taken), the device sends the location to the central remote service manager (e.g., 604 of FIG. 6). The remote service manager stores the location in the user database as the current location of the user. Then it determines which, if any users (e.g., agent devices) and locations of interest (e.g., a store) are within a radius specified by the user. Each time a new user, point of presence, or location of interest appears within the given radius, the central agent server (e.g., 606 of FIG. 6) is sent an agent matching request. Once this processing is done, the central remote service manager sends a reply to the agent device containing a list of the new users or locations nearby, along with information from successful matches (if any).

An alternative example of device discovery utilizes RFID (radio frequency identification). RFID tags are particularly suitable for tagging products because, among other reasons, they are low cost and are already used by many retailers for theft prevention. Device discovery using RFID is also a polling mechanism. In the agent software application, a thread or process periodically queries the agent device's RFID tag reader for nearby tags. Passive RFID tags have no internal power supply. The minute electrical current induced in the tag's antenna by the incoming radio frequency signal from the agent device provides just enough power for the CMOS integrated circuit in the tag to power up and transmit a response. Most passive tags signal by backscattering the carrier signal from the reader. This means that the antenna can be designed both to collect power from the incoming signal and also to transmit the outbound backscatter signal. The response of a passive RFID tag is not necessarily just an ID number; the tag can contain non-volatile EEPROM for storing data. Accordingly, when a user walks through a retail store, and it passes a product having an RFID tag, the agent device's antenna provides power to the passive RFID tag which in turn transmits the characteristics of the product (e.g., data that is stored in a non-volatile EEPROM, or an ID number that the agent device then transmits to a point of presence, e.g., 432 of FIG. 4, for a lookup of the product characteristics). Each time a passive RFID tag appears within the given radius, the central agent server (e.g., 606 of FIG. 6) is sent an agent matching request. This given radius is a predetermined distance that can vary based on the receiver, transmitter, and surrounding conditions. Once this processing is done, the central remote service manager sends a reply to the agent device containing a list of products nearby, along with information from successful matches (if any). RFID tags are not limited to retail product applications, but can be used for a variety of applications, particularly commercial applications (e.g., intelligent inventory tracking). Moreover, as passive RFID tags have a limited detection range, active RFID tags (which have ranges up to several hundred meters or more) can also be used.

Agent Matching Process

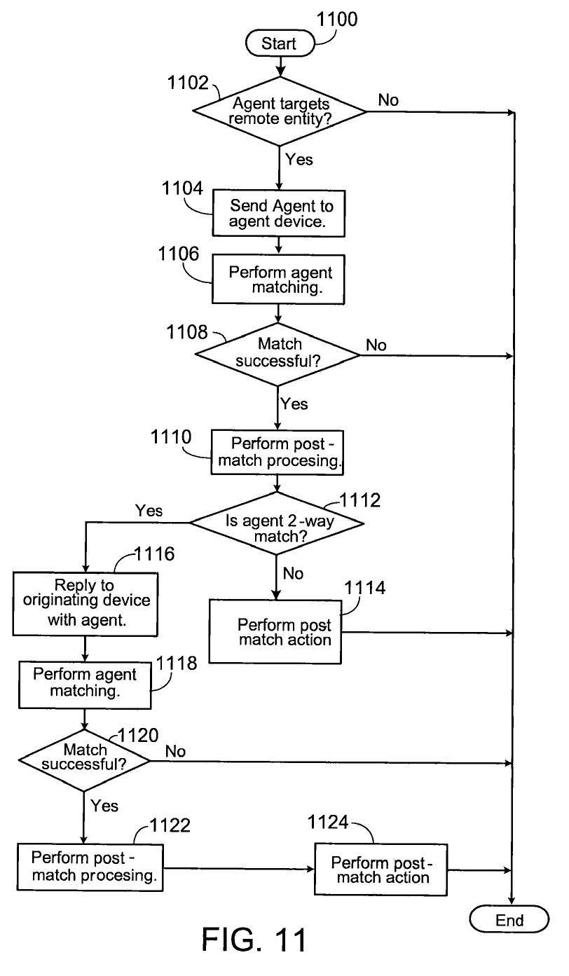

FIG. 11 is a flow diagram illustrating an example of a method for executing agents. This may occur, e.g., between two agent devices, on the central server, or between a mobile agent device and a point of presence. This flow depicts the handling of an agent as if it were the sole agent on an agent device or point of presence in order to illustrate the core agent processing logic. Preferably, the full agent handling logic attempts to process agents in bulk, i.e., send all relevant agents to the discovered device or point of presence in a single message. The start of the flow 1100 is triggered by the proximity of a user (e.g., via an agent device) to another user, product, point of presence, location, or service, or by some other event (e.g. receiving an SMS message). Upon receiving the trigger event, the agent manager determines whether a particular agent targets the remote entity (user, product, location, or service) 1102 in question. In this decision the characteristics of the remote entity are compared with the meta-data in the agent, including remote entity type (user, product, location, or service), the date and time and whether this is the first contact with this particular remote entity. If the agent manager determines the agent should be initiated, the agent is sent to the agent device 1104 for the scenario between two agent devices or between a mobile agent device and a point of presence. When this processing occurs in the central agent server (e.g., 408 of FIG. 4), the transmission of agent parameters does not occur (steps 1104 and 1116).

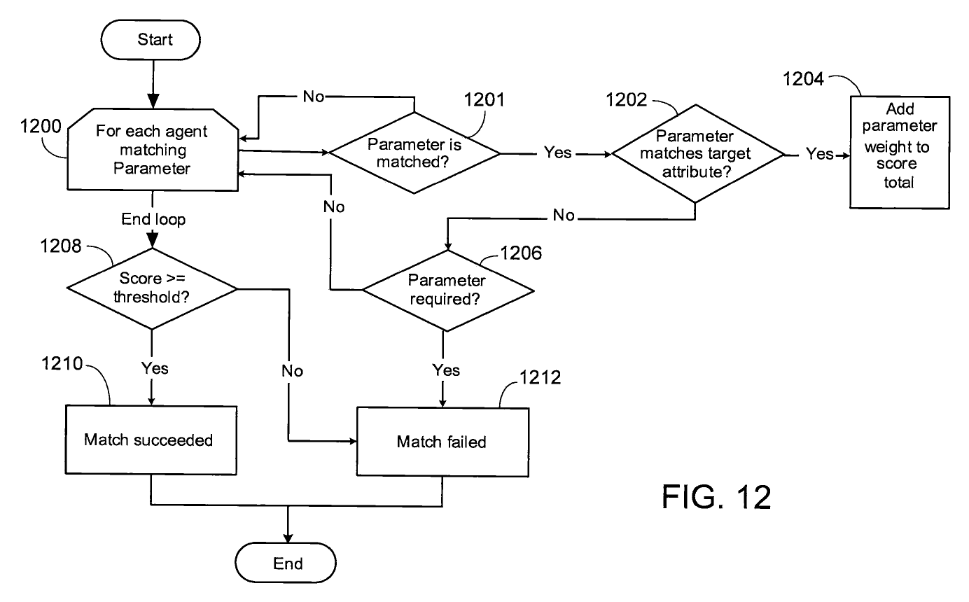

The agent engine (e.g., 508 of FIG. 5) on the agent device performs the agent matching 1106 (see FIG. 12 for detail on the agent matching process). Matching optionally begins by determining whether the targeted device that has received an agent must in turn have the same agent (though the specific attribute values may differ) deployed and active. If this criteria when specified has been met then steps beyond 1106 will commence. An example where matching occurs without both devices sharing a common agent is in the instance that a point of presence detects a device and pushes an offer agent to the device. The offer agent will then execute the match and send back its response.

If there is a match 1108, then post-match processing 1110 is performed and resulting information is attached to the reply to the user. If the agent does not require 2-way matching 1112, the post-match action 1114 indicated by the agent is performed. If the agent requires 2-way matching 1112, then the target replies to originating device with agent parameters 1116. The originating device then will perform agent matching 1118 (see FIG. 12 for detail on the agent matching process). If the match is successful 1120 then post-match processing 1122 is performed, followed by the post-match action 1124. Two-way matching can be used, e.g., to increase match accuracy or as an error correction routine.

Post-match processing 1110, provides the agent the ability to generate information that is based on the match and the parties in the match for use in the post-match action. For example, a dating agent might include a post-match instruction to determine what friends two prospective mates have in common. Post-match actions tell the agent engine what to do once a match has occurred. There are several examples of post-match actions.

Notification is one of the most basic post-match actions. It notifies both participants of the match. For example, notification would notify both users of a dating agent that a romantic match occurred and provide some detail about the other individual. Information generated in a post-match processing instruction also can be included in the notification.

The auto-offer post-match action is commonly used for product or service matches. It automatically makes an offer to purchase an item or services that were matched. If the offer is accepted, the user is notified. If the offer is not accepted, the user is notified and preferably informed of which aspects of the offer did not match.

The wizard post match action is highly versatile, and can be used for a variety of matches. The wizard feature presents a screen to one or both users with the ability for the user to enter some information and/or take an action. For example, a buying agent may find a product the user is looking for and then present the user with a screen that the user the option to buy (and specify a price), save or ignore the match.

The post match action of an offer type agent is to notify the agent device that has sent the offer of the outcome of the match request. If a match has occurred, the response to the sending agent device may include a match score and the match outcome. The agent device sending the offer will then deliver the offer content to the user of a second agent device for subsequent handling and display. When the offer is displayed, the user can view it and take action based on available options for the specific offer (e.g., save it, ignore it, or accept/purchase). In addition to displaying the offer on the second agent device, the offer is automatically added to the user's messaging center as an available offer that the user can review again at a later point in time.

FIG. 12 is a flowchart depicting an agent matching process. The agent matching process is called from within the overall agent handling flow (see FIG. 11 for detail on the overall agent handling flow). An agent contains a set of one or more agent parameters. The agent matching process loops through each agent parameter 1200. Each parameter that is a matching parameter 1201 (non-matching parameters are ignored in the matching process) is evaluated against the corresponding attributes of the target (user, location, product service or item) 1202. The definition of equality depends on the attribute type referred to by the parameter (see attribute types in description of FIG. 13). If the parameter matches, the parameter weight is added to the cumulative score for the agent 1204. If the parameter does not match, it is determined if it is a required parameter 1206. If the parameter is required, the processing loop is broken, and the agent match is marked as failed 1212. If the parameter is not required, the process continues processing agent parameters. Upon completion of the parameter processing loop, the agent score is compared to the threshold assigned to the agent 1208. If the score is equal to or exceeds the threshold, there is a successful match 1210, other wise the match has failed 1212. The threshold can be set by the user, or by the provider of the agent.

Object Model

FIG. 13 describes the agent object model that supports the agent meta-data. An attribute 1314 represents a particular descriptive characteristic or feature that a person, location, service, or item might have. Examples of attributes include:

| Target type | Example Attributes |
|---|---|
| Person | Age |
| | Height |
| | Weight |
| | Hobbies |
| | Favorite book |
| Location | Type (e.g. restaurant, bar, store) |
| | Company Name |
| | Address |
| | Postal Code |
| Service | Type (e.g. accounting) |
| | Vendor |
| | Available Hours |
| Item | Color |
| | Size |
| | Price |

Because attributes are defined in data (preferably stored, at least in part, on agent device data store, e.g., 520 of FIG. 5 and/or agent database 404 of FIG. 4), the catalog of attributes can be expanded over time to accommodate the descriptors utilized in a variety of applications and implementations. The central attribute catalog provides a standard dictionary for use by agents in performing matches. Attributes contain both meta data (e.g., descriptive information, classifications, etc.) and either a single typed value or a set of values. Attributes which contain sets of values from which a user can select one or more values include the actual pre-defined set of values and their state (e.g., selected/unselected). Each attribute has a type that indicates what sort of data can be associated with the attribute. Examples of these include, but are not limited to, the following types:

| Attribute Type | Description |
|---|---|
| Integer | An attribute with a numerical value such as a |
| | phone number, quantity measurement, etc. |
| Boolean | A switched attribute the value of which is either |
| | on/off, true/false, etc. |
| String | Any text value such as a person's name, |
| | description of a product, or an address. |
| Single select choice | An attribute with a set of values only one of |
| | which can be selected at any given time. |
| Single select choice | Same as a single select choice except that it |
| with other option | provides an option in which a user can type his |
| | own value. |
| Multi select choice | Similar to a single select choice with the |
| | exception that a user can select more than one of |
| | a set of values for the attribute. |
| Multi-select choice | Like a multi select choice, this type of attribute |
| with other option | allows for multiple values picked from a list as |
| | well as an option of entering a user defined value |
| | into another field. |
| Integer range | An attribute which stores two numerical values |
| | that represent two ends of a range of numbers. |
| | Used for, e.g., matching things like desirable age |
| | ranges in a dating agent. |
| Height | Attribute which is used for storing a height value |
| | in preferably a normalized way that can then be |
| | matched regardless of measurement format. |
| Age | Age attribute stores a birthday but can return |
| | values as either dates or ages used for attributes |
| | which involve time and elapsed time. |

An attribute 1314 that has a choice type (single select choice, single select choice with other option, multi-select choice, multi-select choice with other option) will have one or more attribute choices 1316 associated with it. An attribute choice defines one of the possible choices that a user may select. The type of the attribute defines whether the user may select one choice or more than one.

An agent 1302 has a set of descriptive data for use in identifying a specific agent to a user, including a type, name and a description. The agent also has a target type, which defines whether the agent is looking for a person, a location, a service or an item. The agent also has an optional image associated with it that is displayed when the user views the agent. This is used for a logo or other branding or identifying image. Additional information specific to the agent is stored in an additional information object 1310. An agent may have zero or more additional info objects. Each additional information object represents a specific piece of information (text, image, number) associated with the agent. The additional information object 1310 has a name, a type and a field containing the information itself. A user may view this information to learn more about the particular agent or to refresh themselves as to the specifics of the agent's task. An example of this might be to include an image of a map in a pub crawl agent that shows directions to and from the target bars.

The agent has one or more parameters, represented by an agent parameter 1304. The agent parameter 1304 references a single attribute object 1304 as its type. The agent parameter 1304 has a default value. If attribute 1314 is a choice set type, it will have on or more attribute choices 1316 associated with it. The agent parameter 1304 has a required flag which, if set to true, indicates that a match on the parameter is required (although not necessarily sufficient) for the agent to match with a target (see step 1206 of FIG. 12). The agent parameter also has a hidden flag which, if set to true, indicates that the parameter is not configurable by a user and should not be displayed on any user interfaces. The hidden flag is used to create “types” of agents where the agent itself has some core criteria for use in a match (e.g., a shoe shopping agent may include a hidden, required agent parameter for a product type attribute with a value of “shoe”). The agent parameter 1304 has a matched flag that defines whether or not the parameter is used in a match. Non-matched parameters are used for transporting agent-specific information that is not used for matching. In the event that a dating type agent is executed, an example of a non-matched parameter would be an “about me” parameter that the user may read and evaluate but is not evaluated for a match by the agent. Non-matched parameters may be used by post-match actions such as displaying the “about me” information for a matched individual.

A post-match action 1308 contains meta-data on standard actions that the agent can invoke once a match has occurred. This catalog of actions must map to actions known by the agent engine components in the agent, in the point of presence, and/or in the agent server. An agent post-match action 1306 associates an agent with a post-match action. The agent 1306 may link to one or more post-match actions 1308. The agent post-match action object 1306 contains a sequence number, which is an ordinal value indicating the sequence in which the agent should execute post-match actions if there are more than one. An example of a post-match event is to notify the user that a match has occurred, include information on what agent matched, what the score was, with whom a match occurred, as well as display any information specified in a post-match processing instruction (see FIG. 12 for a discussion of post-match actions).

A post match process instruction 1312 specifies that the agent engine should perform a particular type of post-match processing to produce dynamic information related to the match. For example, a post-match process instruction could indicate that the agent should calculate how many friends two people have in common following a match. The information that results from such processing is utilized in a notification action specified in the post-match actions.

FIG. 14 is a logical object model depicting the relationship between agents, users and services. A user object 1402 represents a user of the system. It contains a system generated user identifier, as well as key user data, such as username, password and alias. A user can subscribe to one or more agents 1412 (see FIG. 13 for a more detailed description of the agent object model). Subscribing to an agent 1412 creates a user agent object 1404, which relates the user 1402 to a specific agent 1412. The user agent 1404 contains a threshold, preferably a numeric value between 0 and 100, which is utilized by the matching engine (see FIG. 12) to determine what score constitutes a match.

A user agent 1404 contains one or more user agent parameters 1406. There is one user agent parameter 1406 for each agent parameter 1414 (see FIG. 13 for a more detailed description of the agent object model) in the agent 1412 the user agent 1404 is associated with. The user agent parameter 1406 contains the user-assigned value for the corresponding agent parameter 1414, if the agent parameter is not hidden. If the associated agent parameter 1414 is hidden, then the user agent parameter takes 1406 on the default value of the agent parameter 1414. The user agent parameter 1406 has a weight, which is used to indicate the importance the user 1402 places on the parameter 1406. Alternatively, a parameter 1406 can have a weight override if required. If the associated attribute 1430 (identified by the agent parameter 1414) is of a choice set type, then the user agent parameter 1406 has one or more user agent attribute values 1408. A user agent attribute value 1408 is associated with exactly one attribute choice 1432 (see FIG. 13 regarding attribute choice). A user agent attribute value 1408 represents a selected attribute choice 1432 that the user 1402 is looking for as part of the agent criteria. If the attribute 1430 is of a choice set type, the user agent attribute value 1408 is employed in the agent matching process of FIG. 12 when trying to match users with services. If the attribute 1430 is not a choice set type (e.g., the attribute allows open-ended data entry), then the data value contained in the user agent parameter 1406 is employed in the agent matching process of FIG. 12 when trying to match users with services.

A service object 1422 represents a non-user entity in the system, such as a location. It contains a system generated service identifier, as well as key service data, such as name and address. A service 1422 can be associated with zero or more agents 1412. A service 1422 is associated with an agent 1412 through a service agent object 1424, which relates the service 1422 to a specific agent 1412. The service agent 1424 contains a threshold, preferably a numeric value between 0 and 100, which is utilized by the matching engine (see FIG. 12) to determine what score constitutes a match.

A service agent 1424 contains one or more service agent parameters 1426. There must be one or zero service agent parameters 1426 for each agent parameter 1414 in the agent 1412 the service agent 1424 is associated with. If the parameter is required (see, e.g., step 1206 of FIG. 12) it must be commonly shared by both the service 1422 and agent 1412. The service agent parameter 1426 contains the service-assigned value for the corresponding agent parameter 1426 if the agent parameter 1414 is not hidden. If the associated agent parameter 1414 is hidden, then the service agent parameter 1426 takes on the default value of the agent parameter 1414. The service agent parameter 1426 has a weight, which is used to indicate the importance the service 1422 places on the parameter. If the associated attribute 1430 (through the agent parameter 1414) is of a choice set type, then the service agent parameter 1426 has one or more attribute choices 1432. A service agent attribute value 1428 is associated with exactly one attribute choice 1432 (see FIG. 13 for detail on attribute choice). A service agent attribute value 1428 represents a selected attribute choice 1432 that the service 1422 is looking for as part of the agent criteria. If the attribute 1430 is a choice set type, the service agent attribute value 1428 is employed in the agent matching process of FIG. 12 when trying to match users with services. If the attribute 1430 is not a choice set type (e.g., the attribute allows open-ended data entry), then the service agent parameter 1426 is employed in the agent matching process of FIG. 12 when trying to match users with services. In particular, for each agent parameter 1414 associated with a given agent 1412, the process of FIG. 12 will compare the values of 1408 and 1428 and/or 1406 and 1426 in evaluating a match. That process can continue for as many agents 1412 and parameters 1414 as needed to evaluate the match(es) between user 1402 and service 1422.

While the discussion of FIG. 14 provided in detail a description of defining attributes for purposes of service and user agent matches, the process for users and users, users and locations, and users and items (and other permutations thereof) is analogous. Thus, each user, service, location and item defines attribute values for parameters associated with one or more agents. The attribute values then are compared (see FIG. 12) for determining a match (or matches) between users, items, services and/or locations.

FIG. 15A is a logical object model depicting the objects that make up the user attributes and user items. User attributes 1504 represent characteristics of the user 1402, the values of which are represented by user attribute values 1506. User items 1510 represent items such as products, services, or other items that the user 1402 wishes to make discoverable by agents in the system. The data relating to the user 1402 and user items 1510 are preferably stored in central server 408 of FIG. 4 and/or user data store 520 on the agent device 418 of FIG. 5.

The user object 1402 (see FIG. 14 for a more detailed description of the user object) represents an individual user of the system. A user has zero or more user attributes 1504 and user attribute values 1506 that represent specific characteristics of the user, such as height, birth date, age, occupation and/or favorite movies. Each user attribute 1504 is associated with exactly one attribute 1520. Attribute 1520 represents one of the many attributes derived from, e.g., central server 408 of FIG. 4 or agents in the system (e.g., a shopping agent or dating agent that utilizes attributes in addition to those that exist on the central server 408). The user attribute 1504 contains a value specified by the user 1402 (except for user attributes associated with hidden attributes) with a type as determined by the associated attribute 1520. If the associated attribute 1520 is of a choice set type, then the user attribute has one or more attribute choices 1522. A user attribute value 1506 is associated with exactly one attribute choice 1522 (see FIG. 14 for further detail on attribute choice). For attributes 1520 that are the choice set type, a user attribute value 1506 represents a selected attribute choice, and for attributes that are not, user attribute 1504 represents open-ended data (e.g., with reference to the exemplary attributes, the following can be implemented in choice set type: age=28, occupation=engineer, favorite movies=comedies; and the following can be implemented in open-ended type: height=6 feet, birth date=Jul. 22, 1978). The agent matching process (see FIG. 12) utilizes the values of user attribute 1504 and user attribute value 1506. Other possible user attributes 1504 include, for example: gender, sexual orientation, sense of humor, political views, interests, industry, marital status, number of children, and favorite bands.

A user may have zero or more user items 1510 that represent products, services or other items that a user 1402 may want to make available for discovery by the agents of other users. Each user item may have zero or more user item attributes 1512 and user item attribute values 1506 that represent specific facts about the user item 1510. Each user item attribute 1512 is associated with exactly one attribute 1520. Attribute 1520 represents one of the many definable attributes derived from, e.g., central server 408 of FIG. 4 or agents in the system (e.g., a shopping agent or dating agent that utilizes attributes in addition to those that exist on the central server 408). For example, a user 1402 can indicate that he has a bicycle he would like to sell by adding a user item 1510 that represents that bicycle with user item attributes which provide detail about the bicycle (e.g., color=red, type=racing bike, asking price=$100). The user item 1510 has, e.g., a name, a description and one or more associated images. The user item attribute 1512 contains a value specified by the user (except for user item attributes associated with hidden attributes) with a type as determined by the associated attribute 1520. If the associated attribute is of a choice set type, then the user item attribute 1512 has one or more user item attribute choices 1522. A user item attribute value 1514 is associated with exactly one attribute choice 1522, and represents a selected attribute choice 1522. For attributes 1520 that are the choice set type, a user item attribute value 1514 represents a selected attribute choice, and for attributes that are not, user item attribute 1512 represents open-ended data. The agent matching process (see FIG. 12) utilizes the values of user item attribute 1512 and user item attribute value 1514.

FIG. 15B is a logical object model depicting the objects that make up the service attributes and service items. Service attributes 1532 and service attribute values 1534 (for choice set type attributes) represent characteristics of the service 1422. Service item(s) 1540 represent items such as products, services or other items that the service 1422 wishes to make discoverable by agents in the system. The data relating to the service 1422 and service items 1540 can be stored in, e.g., central server 408, point of presence 432, or private server 434 of FIG. 4.

The service object 1422 (see FIG. 14 for more description of the service object 1422) represents a non-user entity in the system. A service 1422 has zero or more service attributes 1532 and service attribute values 1534 that represent specific facts about a service, such as type (e.g., bar) or location (e.g., Chelsea, New York City). Each service attribute 1532 and service attribute value 1534 is associated with exactly one attribute 1520. Attribute 1520 represents one of the many definable attributes derived from, e.g., central server 408 of FIG. 4 or agents in the system (e.g., a shopping agent or dating agent that utilize attributes in addition to those that exist on the central server 408). The service attribute 1532 contains a value specified by a representative of the service (except for service attributes associated with hidden attributes) with a type as determined by the associated attribute 1520. If the associated attribute 1520 is of a choice set type, then the service attribute 1532 has one or more service attribute choices 1522. A service attribute value is associated with exactly one attribute choice 1522 (see FIG. 13 for details on attribute choice). A service attribute value 1534 represents a selected attribute choice 1522. The agent matching process (see FIG. 12) utilizes the values of service attribute 1532 and service attribute value 1534.

A service 1422 has zero or more service items 1540 that represent products, services or other items that a service may want to make available for discovery by the agents of users. Each service item 1540 may have zero or more service item attributes 1542 and service item attribute values 1544 that represent specific facts about the service item 1540. Each service item attribute 1542 is associated with exactly one attribute 1520. Attribute 1520 represents one of the many definable attributes derived from, e.g., central server 408 of FIG. 4 or agents in the system (e.g., a shopping agent or dating agent that utilize attributes in addition to those that exist on the central server 408). For example, a service 1422 can indicate that it has a purse for sale by adding a service item 1540 that represents that purse with service item attributes which provide detail about the purse (e.g. color=burgundy, type=formal, price=$500). The service item 1540 has, e.g., a name, a description and one or more associated images. The service item attribute 1542 contains a value specified by a representative of the service (except for service item attributes associated with hidden attributes) with a type as determined by the associated attribute 1520. If the associated attribute is of a choice set type, then the service item attribute has one or more attribute choices 1542. A service item attribute value 1544 is associated with exactly one attribute choice 1522 and represents a selected attribute choice 1522. The agent matching process (see FIG. 12) utilizes the values of service item attribute 1542 and service item attribute value 1544.

Implementations

The foregoing embodiments are applicable to many situations. Examples include dating, social networking, conferences, games, retail, venues and advertising.

Dating

Proximity services for dating combine the proximity of two users with matching capabilities that utilize match criteria that are compared to user demographics, preferences and other characteristics, and then weighted to derive a weighted match value for dating compatibility. Users are notified when a match threshold has been met for minimum compatibility. The users then can conduct relationship building tasks.

Some implementations enable matching of users to determine their compatibility by using either agent device-hosted/server-hosted or distributed data and functionality that is triggered when the proximity between two users' agent devices is within a specified distance. Users can browse information about their match that includes information that may come from their match's agent device or be downloaded from a server combined with user proprietary information that is used to further enhance the information about a person with whom someone shares some form of connection/relationship. Relationship building features can include, but are not limited to: (1) presence sharing that notifies users when people they have existing relationships with or would like to have a relationship with are nearby (friend finder); (2) profile viewing that allows users to view information about other users; (3) messaging for communication between users; (4) photo gallery sharing; (5) contact information sharing; and (6) anonymous communication between users wherein the user's phone number and other personally identifiable information is not exchanged.

Social Networking

Proximity services for social networking allow users to know when friends, colleagues, business contacts and members of their social network are nearby. Additionally, the agent matching process notifies users that there is someone nearby who might be of interest for social, business or other reasons, based on a successful match between two people. Proximity services for social networking can extend beyond the capabilities utilized for dating by adding the concept of group membership—two users may have indirect connections through inclusion in a group (e.g., a professional association) thereby making it possible to maintain a relationship through a common group instead of person to person. Proximity related services for relationship building are similar to those described in the dating implementation. Social networking can utilize overlapping dating criteria with additional unique application specific match criteria and richer user profiles to deliver a broad range of applications that include, but are not limited to, friend finders, job finders, networking and information sharing applications.

Examples of uses for proximity-enabled social networking include: (1) presence notification of the proximity to members of a personal network, e.g., business users walking down the street will know the customer they have been trying to get in touch with is across the street and can approach them immediately to make a connection or friends who never would have known they were in the same neighborhood suddenly can cross paths and reconnect thanks to notification of their proximity; (2) expanded internet presence combines sharing of proximity of individuals who share relationships by adding internet based presence to the presence list, e.g., users of instant messaging platforms can share their presence over the internet and have their presence combine both internet presence with proximity presence in a single integrated list; (3) group sharing enables users who jointly belong to a single group (people who work for a particular company, belong to a fraternity, or social group for example) can be connected automatically and their presence will appear on the presence list of the application when users are within proximity; (4) contact sharing expands the concept of business cards sharing to the sharing of detailed profiles that include details provided by the contact themselves, third parties (e.g., endorsements, ratings and comments), and detailed enhancements contributed by the contact information recipient; and (5) common network sharing that informs the user of the expanded networks two connected individuals share by identifying common contacts, e.g., in addition to viewing common contacts users can view the personal networks of individuals with whom they share a connection or relationship.

Features which support relationship/contact management include (1) integration with agent device address book enables proximity services to leverage existing contact information databases and (2) contact loading/synchronization through data upload to a website and synchronization down to an agent device or synchronization between an agent device and computer.

Conferences

Conferences bring together large and dense groups of people who share interests in a common theme (or themes) and who often are interested in various forms of social and business networking. Proximity services help attendees connect with people they have relationships with and find people they are interested in building new relationships with. Buyers and sellers can find each other, or buyers can find specific products they are seeking just by walking around a conference area (see also earlier discussion of RFID). In addition to connecting people at conferences, proximity services enable conference sponsors to track attendance and distribute information.

Games

Proximity services on mobile agent devices provide a new aspect to old games and a rich feature set for future games that leverage any combination of proximity detection, matching and messaging for game play. Scavenger hunts, games of assassin and even tag are examples of games that can be enhanced through the use of proximity services. Games that utilize proximity services enable players to automatically detect the presence of others when they are nearby and provide an electronic confirmation of the proximity as well as actions taken between game players.

Retail

The retail embodiment leverages peer-to-peer agent device proximity services (see also earlier discussion of RFID) as well as person to location proximity services. In a person-to-retail location scenario, a retail outlet can provide a number of proximity services that include, but are not limited to: (1) the ability for mobile users to configure shopping agents with services and products being sought, e.g., as the user comes in proximity of an outlet, the agent will query the business for desired products/services; in the event one is found the user will be informed and can then take action to purchase the desired product/service; (2) retailers dynamically can adjust item characteristics like price, product availability and other essential retail business metrics to achieve the highest closure rate possible, e.g., in a peer-to-peer model users can place product offers while buyers can be notified of products users are looking for in their proximity; (3) customers of certain demographics (e.g., frequent buyers) can be segmented and given premium services; and (4) orders can be executed from an agent device directly to the retailer thereby cutting lines.

Venues

In venues such as sports arenas, exhibitions, concert halls or social environments like bars proximity services provide a platform for delivering consumer oriented services like VIP access and queue cutters, seat finders, affiliate programs and a host of customer management functions which can be targeted at and delivered to mobile users of agent device proximity services. Furthermore, venues offering on-site proximity services can gain insight into consumer behavior and demographics in exchange for hosting, e.g., points of presence and services.

Advertising

Proximity advertising provides users with contextual promotion of products and services made available to them by an advertiser. Advertisements are displayed on the agent device and can be targeted using detailed profile information, contextual information such as time, duration and location proximity. Using proximity detection of agent devices, an agent device or point of presence can send an offer match request to a device and determine the applicability of the offer (scored by matching the offer with the user). In the event that the offer meets an offeror or offeree-specified threshold of accuracy, the agent device will send an offer which will be delivered to the other agent device. Offers delivered can include many media types including text, images, audio, and video.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

A number of embodiments of the invention have been described. Nevertheless, it will be understood that various modifications may be made without departing from the spirit and scope of the invention. For example, the present invention can be embodied in various applications including retail, dating, gaming and advertising. Moreover, the agent device may take various forms (e.g., a cellular phone, PDA, laptop computer, GPS transceiver) and have various capabilities (e.g., CDMA, GPS, Bluetooth®, ZigBee™, RFID, WiFi®, WiMax, SMS). Accordingly, other implementations are within the scope of the claims.

What is claimed is:

1. A method for providing contextual information in a network of devices configured for executing one or more agents, the method comprising:
providing a first agent to a first device associated with a first entity, wherein the first agent enables the first entity to specify one or more first attributes associated with a first goal;
providing a second agent to a second device associated with a second entity, wherein the second device comprises second attributes associated with the second entity;
providing proximity data to the first device and the second device indicative of the proximity of the first device to the second device; and
wherein execution of the first agent occurs only if at least one predetermined criterion is met, whereupon execution, the first and the second agents compare the first attributes to the second attributes.

2. A method according to claim 1 wherein at least one agent comprises meta-data.

3. A method according to claim 1 further comprising:
providing a third agent to the first device associated with the first entity, wherein the third agent enables the first entity to specify one or more third attributes associated with a third goal.

4. A method according to claim 1 further comprising:
providing an agent platform to at least one device for enabling receipt and execution of multiple agents, wherein the agents comprise meta-data.

5. A method according to claim 1 wherein at least one device is a mobile phone, computer, PDA, server or wireless device.

6. A method according to claim 1 wherein at least one entity is a person, location, product or service.

7. A method according to claim 1 wherein at least one attribute relates to a person, location, product or service.

8. A method according to claim 1 wherein at least one goal relates to a person, location, product or service.

9. A method according to claim 1 wherein providing proximity data includes receiving a location signal.

10. A method according to claim 1 wherein at least one criterion is that the proximity of the first device to the second device is less than a predetermined distance.

11. A method according to claim 1 further comprising:
notifying at least one entity whether the first and second attributes meet a predefined degree of similarity.

12. A method according to claim 11 further comprising:
providing information associated with the second attributes to the first device.

13. A method according to claim 12 wherein the information relates to the characteristics of a person, location, item, or service.

14. A method according to claim 1 further comprising:
notifying at least one device whether another device is within a predetermined distance.

15. A method for providing contextual information in a network of devices configured for executing one or more agents, the method comprising:
downloading a first agent from a server to a first device associated with a first entity;
specifying one or more first attributes to the first agent, wherein the first attributes are associated with a first goal;
detecting the proximity of the first device to a second device, wherein the second device comprises second attributes associated with a second entity, the second device further comprising a second agent; and
executing the first agent only if at least one predetermined criterion is met, whereupon execution, the first and second agents compare the first attributes to the second attributes.

16. A method according to claim 15 wherein at least one agent comprises meta-data.

17. A method according to claim 15 further comprising:
downloading a third agent from a server to the first device associated with a first entity;
specifying one or more third attributes to the third agent, wherein the third attributes are associated with a third goal.

18. A method according to claim 15 further comprising:
downloading an agent platform to the first device for enabling receipt and execution of multiple agents, wherein the agents comprise meta-data.

19. A method according to claim 15 further comprising:
notifying at least one entity whether the first and second attributes meet a predefined degree of similarity.

20. A method according to claim 19 further comprising:
prompting at lease one entity for input if the first and second attributes meet the predefined degree of similarity.

21. A method according to claim 19 further comprising:
receiving, at the first device, information associated with the second attributes.

22. A method according to claim 21 wherein the information relates to the characteristics of a person, location, item, or service.

23. A method according to claim 15 further comprising:
receiving a notification that at least one device is within a predetermined distance of the first device.

24. A method according to claim 15 wherein at least one device is a mobile phone, computer, PDA, server or wireless device.

25. A method according to claim 15 wherein at least one entity is person, location, product or service.

26. A method according to claim 15 wherein at least one attribute relates to a person, location, product or service.

27. A method according to claim 15 wherein at least one goal relates to a person, location, product or service.

28. A method according to claim 15 wherein at least one attribute is specified via a website.

29. A method according to claim 15 wherein detecting the proximity of the first device to a second device comprises comparing GPS data associated with the first device and second device.

30. A method according to claim 15 wherein detecting the proximity of the first device to a second device comprises receiving a wireless signal.

31. A method according to claim 15 wherein at least one criterion is that the proximity of the first device to the second device is less than a predetermined distance.

32. A system for generating contextual information in a network of devices configured for executing one or more agents, the system comprising:
a first device programmed with a first agent, wherein the first device is associated with a first entity;
logic on the first device for specifying one or more first attributes to the first agent, the first attributes associated with a first goal;
a second device programmed with a second agent, wherein the second device is associated with a second entity;
logic on the second device for specifying one or more second attributes associated with the second entity;
first proximity detection structure associated with the first device for detecting the proximity of another device and second proximity detection structure associated with the second device for detecting the proximity of another device, wherein the first and the second proximity detection structures cooperate to detect the proximity of the first device and the second device to each other; and
logic for executing the first agent only if at least one predetermined criterion is met, whereupon execution, the first agent and the second agent compare the first attributes to the second attributes.

33. A system according to claim 32 wherein at least one agent comprises meta-data.

34. A system according to claim 32 wherein at least one device is programmed with an agent platform for enabling receipt and execution of multiple agents, wherein the agents comprise meta-data.

35. A system according to claim 32 wherein at least one device is programmed with logic to generate a notification when another device is within a predetermined distance.

36. A system according to claim 32 wherein at least one device is a mobile phone, computer, PDA, server or wireless device.

37. A system according to claim 32 wherein at least one entity is a person, location, product or service.

38. A system according to claim 32 wherein at least one attribute relates to a person, location, product or service.

39. A system according to claim 32 wherein at least one goal relates to a person, location, product or service.

40. A system according to claim 32 wherein the proximity detection structure comprises a GPS receiver.

41. A system according to claim 32 wherein the proximity detection structure comprises a wireless transceiver.

42. A system according to claim 32 wherein at least one criterion is that the proximity of the first device to the second device is less than a predetermined distance.

43. A system according to claim 32 further comprising:
one or more servers comprising logic for executing agents, wherein the one or more servers are coupled to the logic for executing the first agent.

44. A system according to claim 32 further comprising:
one or more servers comprising a storage structure for storing agents for transmission from at least one server to at least one device.

45. A system according to claim 32 further comprising:
logic for notifying at least one entity whether the first attributes and second attributes meet a predetermined degree of similarity.

46. An article comprising a machine-readable medium that stores machine-executable instructions for causing a machine to:
receive one or more first attributes, wherein the first attributes are associated with a first goal;
provide the first attributes to a first executable agent;
detect the proximity of the machine to a second device, wherein the second device comprises a second executable agent and second attributes descriptive of an entity; and
execute the first agent only if at least one predetermined criterion is met, whereupon execution, the first and second agents compare the first attributes to the second attributes.

47. An article according to claim 46 wherein at least one agent comprises meta data.

48. An article according to claim 46 further causing a machine to:
receive multiple executable agents, wherein the agents comprise meta-data.

49. An article according to claim 46 further causing a machine to:
generate a notification whether the first and second attributes meet a predetermined degree of similarity.

50. An article according to claim 46 further causing a machine to:
generate a notification whether the machine is within a predetermined distance to at least one device comprising an agent.

51. An article according to claim 46 further causing a machine to:
determine whether the proximity of the machine to the second device is less than a predetermined distance.

52. An article according to claim 46 wherein at least one attribute relates to a person, location, product or service.

53. An article according to claim 46 wherein at least one goal relates to a person, location, product or service.

54. A method for providing contextual information in a network of devices configured for executing one or more agents, the method comprising:
determining the context of a first user of a device, the context of the first user comprising (1) the location of the first user; (2) attributes descriptive of the first user; and (3) one or more goals of the first user; and
executing an agent on the device, wherein the agent searches within a predetermined distance from the first user for a second user that matches at least one goal of the first user.

55. A method according to claim 54 further comprising:
notifying at least one user whether a second user matches at least one goal of the first user.

56. A method according to claim 54 wherein a device is a mobile phone, computer, PDA, server or wireless device.

57. An apparatus for use in a network of devices comprising:
memory structure for storing one or more executable agents;
logic for specifying one or more first attributes to a first agent, the first attributes associated with a first goal;
proximity detection structure for detecting the proximity of the first device to a second device;
logic for executing the first agent only if at least one predetermined criterion is met; and
logic for comparing the first attributes with second attributes on the second device.

58. An apparatus according to claim 57 wherein the apparatus is a mobile phone, computer, PDA, server or wireless device.

59. An apparatus according to claim 57 wherein at least one agent comprises meta-data.

60. An apparatus according to claim 57 further comprising:
agent platform logic for receiving and executing multiple agents, wherein the agents comprise meta-data.

61. An apparatus according to claim 57 further comprising:
logic for generating a notification whether the first attributes and second attributes meet a predetermined degree of similarity.

62. An apparatus according to claim 57 wherein at least one criterion is that the proximity of the first device to the second device is less than a predetermined distance.

63. An apparatus according to claim 57 wherein the proximity detection structure is adapted to receive a wireless signal.
